(19) United States
(12) Patent Application Publication
(10) Pub. No.: US 2022/0230074 A1
(43) Pub. Date: Jul. 21, 2022

(54) TRAINING DEVICE, TRAINING METHOD, AND PREDICTION SYSTEM

(71) Applicant: NIPPON TELEGRAPH AND TELEPHONE CORPORATION, Tokyo (JP)

(72) Inventors: Atsutoshi KUMAGAI, Musashino-shi, Tokyo (JP); Tomoharu IWATA, Musashino-shi, Tokyo (JP)

(73) Assignee: NIPPON TELEGRAPH AND TELEPHONE CORPORATION, Tokyo (JP)

(21) Appl. No.: 17/608,158

(22) PCT Filed: May 17, 2019
(86) PCT No.: PCT/JP2019/019662

§ 371 Date: Nov. 2, 2021

(51) Int. Cl. G06N 5/02; G06N 5/04

(52) U.S. Cl. CPC G06N 5/022; G06N 5/04

(57) ABSTRACT

A training device (10) includes a training data input unit (11) that accepts input of labeled data of a source domain and/or unlabeled data of a source domain as training data, a feature extraction unit (12) that converts data unique to each source domain of which input has been accepted by the training data input unit (11), to a feature vector, and a training unit (13) that trains a predictor (141) that performs data embedding suited to an input domain, in accordance with metric learning by using the feature vector of each source domain.

### TECHNICAL FIELD

The present invention relates to a training device, a training method, and a prediction system.

### BACKGROUND ART

In machine learning, a sample generation distribution that is obtained in training of a model (e.g., a classifier) and a sample generation distribution that is obtained in a test of the model (prediction using the model) may differ from each other. The term “sample generation distribution” refers to a distribution that describes the probability of the occurrence of each sample. For example, the probability of the occurrence of a sample that was 0.3 in training of the model may change to 0.5 in a test of the model.

In the case of spam mail classification in the field of security, for example, spam mail creators every day create spam mails that have new features to slip through classification systems. Therefore, a spam mail generation distribution changes with time. Also, in the case of image classification, an image generation distribution largely changes due to a difference in the image capturing device (digital single lens reflex camera, feature phone, etc.) or the shooting environment (intensity of the light source, background, etc.) even if the same object is imaged.

In such a case, if a method of common metric learning is used as machine learning, there arises a problem in that the performance is largely degraded. Here, “metric learning” is a general term that refers to methods for learning data embedding (low-dimensional vector expression of data) such that similar data pieces are arranged close to each other and different data pieces are arranged away from each other.

In the following description, a domain in which there is a task to be solved will be referred to as a “target domain”, and a domain that relates to the target domain will be referred to as a “source domain”. In the above-described case, a domain to which data used in the test belongs is the target domain, and a domain to which data used in the training belongs is the source domain.

If a large amount of labeled data of the target domain is available, it is best to train a model using the labeled data of the target domain. However, in many applications, it is difficult to obtain a sufficient amount of labeled data of the target domain. Therefore, a method has been proposed in which, in addition to labeled data of the source domain, unlabeled data of the target domain, which can be collected at a relatively low cost, is used in training to acquire data embedding that is suited to test data even if a data generation distribution differs between the training and the test. Labeled data is data to which training information such as “similar” or “dissimilar” is added.

However, in some actual problems, there are cases where data of the target domain cannot be used for training. For example, along with the spread of IoT (Internet of Things) in recent years, complex processing such as visualization or data analysis is performed in IoT devices in more and more cases. Since IoT devices do not have sufficient computation resources, it is difficult to carry out burdensome training in these terminals even if data of the target domain can be acquired. Note that prediction can be carried out in the terminals of IoT devices because the cost of prediction is low when compared to training.

Also, cyberattacks on IoT devices are rapidly increasing. Examples of IoT devices include cars, televisions, and smartphones, and in the case of cars, features of data vary according to the type of cars. As described above, there are various types of IoT devices, and new IoT devices are launched one after another. Therefore, if high-cost training is carried out every time a new IoT device (target domain) appears, it is not possible to immediately deal with cyberattacks.

Conventionally, methods for learning data embedding that is expected to be suited to the target domain by using “only” labeled data of a plurality of source domains have been proposed (see NPL 1 and NPL 2). In these methods, data of the target domain is not used in training, and therefore these methods can be applied even to cases like those described above.

Specifically, in these conventional methods, information that is common to all domains is extracted from labeled data of the plurality of source domains, and data embedding that does not vary depending on domains is learned using the extracted information. As described above, in the conventional methods, embedding that is common to the domains is learned, and therefore it is expected that a good operation can be similarly achieved with respect to the target domain that could not be obtained at the time of training.

### CITATION LIST

### Non Patent Literature

[NPL 1] Shibin Parameswaran and Kilian Q Weinberger. “Large Margin Multi-Task Metric Learning”, In NeurIPS, 2010.
[NPL 2] Binod Bhattarai, Gaurav Sharma, and Frederic Jurie, “CP-mtML: Coupled Projection multi-task Metric Learning for Large Scale Face Retrieval”, In CVPR, 2016.

### SUMMARY OF THE INVENTION

### Technical Problem

As described above, in the conventional methods, only information that is common to domains is extracted, and data embedding that does not vary depending on domains is learned. In other words, in the conventional methods, information that is unique to each domain is ignored in the learning. Therefore, with the conventional methods, information loss occurs and it is highly likely that data embedding that is suited to data of the target domain cannot be learned.

Also, in the conventional methods, it is assumed that each domain used for training includes at least a small amount of labeled data. Therefore, in the conventional methods, information regarding a domain that does not include labeled data at all, i.e., information regarding a domain that only includes unlabeled data cannot be used for training.

The present invention was made in view of the foregoing, and has an object of providing a training device, a training method, and a prediction system that can prevent information loss and predict data embedding that is suited to a target domain regardless of the presence or absence of labels of data of a source domain for training.

### Means for Solving the Problem

To solve the problem described above and achieve the object, the training device according to the present invention includes: an input unit configured to accept input of labeled data of a source domain and/or unlabeled data of a source domain as training data: a feature extraction unit configured to convert data unique to each source domain of which input has been accepted by the input unit, to a feature vector; and a training unit configured to train a predictor that performs data embedding suited to an input domain, in accordance with metric learning by using the feature vector of each source domain.

A training method according to the present invention is a training method to be executed by a training device, including: accepting input of labeled data of a source domain and/or unlabeled data of a source domain as training data: converting data unique to each source domain of which input has been accepted, to a feature vector; and training a predictor that performs data embedding suited to an input domain, in accordance with metric learning by using the feature vector of each source domain.

A prediction system according to the present invention is a prediction system including: a training device configured to train a predictor; and a prediction device configured to predict data embedding suited to a target domain by using the predictor, wherein the training device includes: a first input unit that accepts input of labeled data of a source domain and/or unlabeled data of a source domain as training data; a first feature extraction unit that converts data unique to each source domain of which input has been accepted by the first input unit, to a feature vector; and a training unit that trains a predictor that performs data embedding suited to an input domain, in accordance with metric learning by using the feature vector of each source domain, and the prediction device includes: a second input unit that accepts input of unlabeled data of a target domain that is a prediction target; a second feature extraction unit that converts data unique to the target domain of which input has been accepted by the second input unit, to a feature vector; and a prediction unit that performs data embedding suited to the target domain based on the feature vector converted by the second feature extraction unit, by using the predictor trained by the training unit.

### Effects of the Invention

According to the present invention, it is possible to prevent information loss and predict data embedding that is suited to a target domain regardless of the presence or absence of labels of data of a source domain for learning.

### BRIEF DESCRIPTION OF DRAWINGS

FIG. 1 is a diagram showing metric learning.

FIG. 2 is a diagram showing an overview of training of a predictor in a prediction system according to an embodiment.

FIG. 3 is a diagram showing an example configuration of the prediction system according to an embodiment.

FIG. 4 is a flowchart showing an example procedure of training processing performed by a training device shown in FIG. 3.

FIG. 5 is a flowchart showing an example procedure of prediction processing performed by a prediction device shown in FIG. 3.

FIG. 6 is a diagram showing an example of a computer with which the training device and the prediction device are realized through execution of a program.

### DESCRIPTION OF EMBODIMENTS

The following describes an embodiment of the present invention in detail with reference to the drawings. Note that the present invention is not limited by the embodiment. In the drawings, the same portions are denoted with the same reference signs.

### Embodiment

The following describes an embodiment of a training device, a training method, and a prediction system according to the present application in detail based on the drawings. Note that the training device, the training method, and the prediction system according to the present application are not limited by the embodiment.

First, an overview of training of a predictor in the prediction system according to the embodiment will be described. In the present embodiment, the predictor is trained using metric learning of machine learning. “Metric learning” is a general term that refers to methods for learning data embedding (low-dimensional vector expression of data) such that similar data pieces are arranged close to each other and different data pieces are arranged away from each other. Data embedding that is obtained through metric learning is useful in various tasks in the field of machine learning, such as classification, clustering, and visualization.

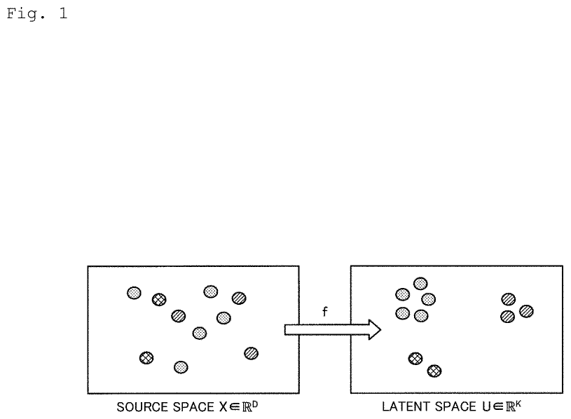

FIG. 1 is a diagram showing metric learning. In FIG. 1, each circle mark corresponds to a data point. Data pieces that are shown with the same color are similar to each other, and data pieces that are shown with different colors are dissimilar. Note that information indicating similarity or dissimilarity between data pieces needs to be given in advance.

As shown in FIG. 1, data pieces are arranged apart from each other in a source space X. Here, desired data embedding (see a latent space U) can be acquired with respect to the data in the source space X by learning appropriate mapping f.

In the present embodiment, the predictor is a predictor that predicts a data embedding space of data that is a prediction target, for example. Training data that is used to train the predictor is labeled data and/or unlabeled data of a plurality of source domains.

In the following description, a target domain is a domain in which there is a task to be solved. A source domain refers to a domain that differs from the target domain, but relates to the target domain. For example, if the task to be solved in the target domain is “acquisition of data embedding of newspaper articles”, the target domain is “newspaper articles”, and source domains are “SNS (Social Networking Service)”, “review articles”, and the like. Newspaper articles, writing in SNS, and review articles are similar in that they are Japanese sentences, although there is a difference between them in use of words and the like. Therefore, it is highly likely that writing or remarks made in SNS can be effectively used to acquire data embedding of newspaper articles.

Assume that training data such as labeled data and/or unlabeled data is data that belongs to the source domains. Assume that data that is the prediction target belongs to the target domain.

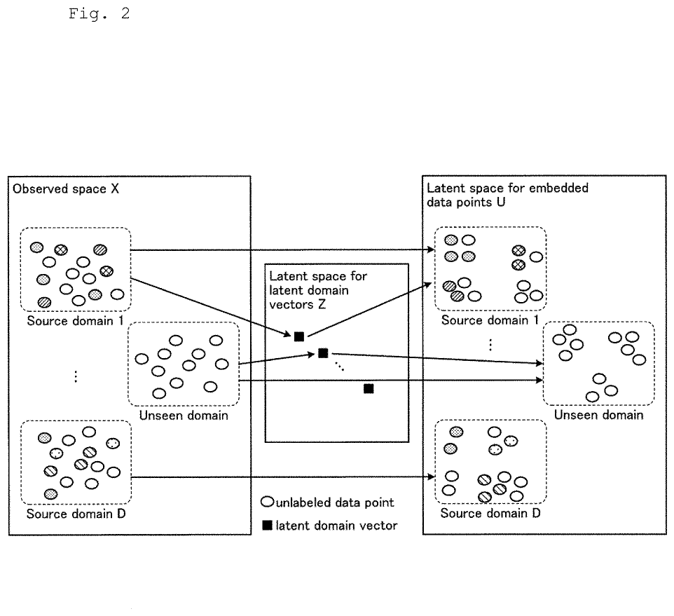

FIG. 2 is a diagram showing an overview of training of the predictor in the prediction system according to the embodiment. In the prediction system according to the present embodiment, a latent domain vector (the center diagram in FIG. 2) that represents a feature of a domain is presumed from a sample set of each domain (the left diagram in FIG. 2), and data embedding that is suited to the domain (the right diagram in FIG. 2) is output based on the latent domain vector and the sample set. In the prediction system according to the present embodiment, the above relationship is learned using data of a plurality of source domains, and therefore data embedding that is suited to the target domain can be immediately output without carrying out learning when a sample set of the target domain is given.

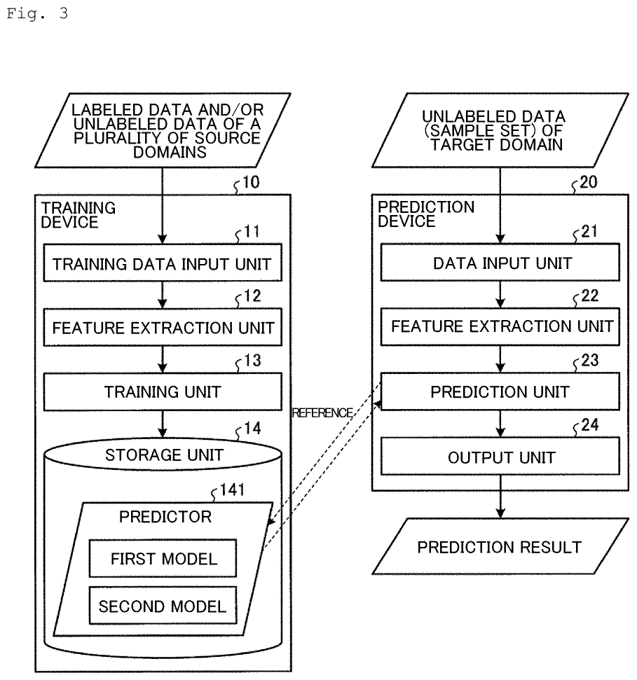

Next, an example configuration of the prediction system according to the present embodiment will be described using FIG. 3. FIG. 3 is a diagram showing the example configuration of the prediction system according to the embodiment. As shown in FIG. 3, the prediction system includes a training device 10 and a prediction device 20. Note that the training device 10 and the prediction device 20 may also be realized using a single device that includes functions of both of the devices, rather than separate devices.

The training device 10 trains a predictor that outputs data embedding that is unique to a domain based on a sample set of each domain, by using labeled data and/or unlabeled data of a plurality of source domains that are given in training.

When a sample set of the target domain is given, the prediction device 20 outputs data embedding that is suited to the target domain by referring to the predictor trained by the training device 10.

[Training Device]

Next, a configuration of the training device 10 will be described with reference to FIG. 3. The training device 10 is realized as a result of a predetermined program being read into a computer or the like that includes a ROM (Read Only Memory), a RAM (Random Access Memory), a CPU (Central Processing Unit), and the like, and the CPU executing the predetermined program. Also, the training device 10 includes an NIC (Network Interface Card) or the like, and can communicate with another device via an electric communication line such as a LAN (Local Area Network) or the Internet. As shown in FIG. 3, the training device 10 includes a training data input unit 11 (first input unit), a feature extraction unit 12 (first feature extraction unit), a training unit 13, and a storage unit 14.

The training data input unit 11 accepts input of labeled data and/or unlabeled data of a plurality of source domains, as training data, and outputs the training data to the feature extraction unit 12.

Here, labeled data is a set of samples and training information regarding the samples. As the training information, information that indicates that two samples are “similar” or “dissimilar” is conceivable. Ina case where the samples are texts, for example, if the content of both texts is sports, a tag of “similar” is added, and if the content of a text is sports and the content of another text is politics, a tag of “dissimilar” is added. As for labeled data, not only training information indicating “similar” or “dissimilar”, but also class information or the like is applicable, for example.

On the other hand, unlabeled data is a set of samples to which label information is not added. In the case of the example described above, a set that only includes texts corresponds to unlabeled data. In the following description, with respect to each domain, it is assumed that training information is added to some sample pairs, and training information is not added to the other samples. Note that the present embodiment is also applicable to a case where some domains only include unlabeled data.

The feature extraction unit 12 converts each sample that is training data to a feature vector. Here, “feature vector” refers to an expression of a required feature of data using an n-dimensional numerical vector. The feature extraction unit 12 performs conversion to the feature vector using a method that is commonly used in machine learning. In a case where the data is a text, for example, the feature extraction unit 12 uses a method in which morphological analysis is used, a method in which n-gram is used, a method in which delimiters are used, or the like. The feature extraction unit 12 also converts a label to a numerical value that indicates the label. The feature extraction unit 12 converts data that is unique to each source domain of which input has been accepted by the training data input unit 11, to a feature vector.

The training unit 13 trains a predictor 141 that outputs data embedding that is suited to each domain based on a sample set of the domain, by using labeled data and/or unlabeled data of the source domains after the feature extraction. The training unit 13 trains the predictor 141 that performs data embedding suited to each source domain, in accordance with metric learning by using the feature vector of the source domain. The predictor 141 is a model that predicts data embedding that is suited to a source domain when a feature vector of the source domain is input, and uses not only labeled data of the source domain, but also unlabeled data of the source domain, as training data.

The predictor 141 trained by the training unit 13 is stored in the storage unit 14. The predictor 141 includes a first model and a second model.

When a set of feature vectors that belong to a domain is input, the first model estimates a latent feature vector that is a latent variable of each feature vector of the input domain and a latent domain vector that indicates information regarding the domain that is information regarding a data set of the input domain. The second model outputs a feature vector of the domain when the domain latent feature vector and the latent domain vector that are estimated by the first model are input. The training unit 13 optimizes parameters of the first model and the second model using input to the first model, output of the first model, and output of the second model.

[Prediction Device]

A configuration of the prediction device 20 will be described with reference to FIG. 3. The prediction device 20 is realized as a result of a predetermined program being read into a computer or the like that includes a ROM, a RAM, a CPU, and the like, and the CPU executing the predetermined program. Also, the training device 10 includes an NIC or the like, and can communicate with another device via an electric communication line such as a LAN or the Internet. As shown in FIG. 3, the prediction device 20 includes a data input unit 21 (second input unit), a feature extraction unit 22 (second feature extraction unit), a prediction unit 23, and an output unit 24.

The data input unit 21 accepts input of unlabeled data (sample set) of a target domain that is a prediction target, and outputs the unlabeled data of the target domain to the feature extraction unit 22.

The feature extraction unit 22 extracts a feature value of unlabeled data of each target domain of which input has been accepted by the data input unit. The feature extraction unit 22 converts a sample that is a prediction target to a feature vector. Here, the feature value is extracted using the same procedure as that used by the feature extraction unit 12 of the training device 10. Accordingly, the feature extraction unit 22 converts data that is unique to the target domain of which input has been accepted by the data input unit 21, to a feature vector.

The prediction unit 23 predicts data embedding from the sample set by using the predictor 141 trained by the training unit 13. The prediction unit 23 performs data embedding that is suited to the target domain based on the feature vector converted by the feature extraction unit 22, by using the predictor 141 trained by the training unit 13. The output unit 24 outputs the result of prediction performed by the prediction unit 23.

[Procedure of Training Processing]

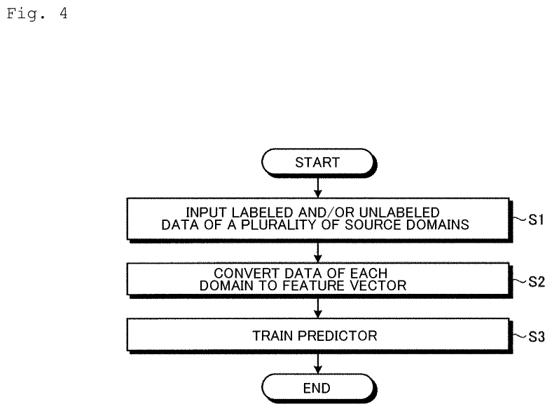

Next, a procedure of processing performed by the training device 10 will be described with reference to FIG. 4. FIG. 4 is a flowchart showing an example procedure of training processing performed by the training device 10 shown in FIG. 3.

As shown in FIG. 4, in the training device 10, the training data input unit 11 accepts input of labeled data and/or unlabeled data of a plurality of source domains, as training data (step S1). The feature extraction unit 12 converts data of each domain of which input was accepted in step S1, to a feature vector (step S2).

Then, the training unit 13 trains the predictor 141 for predicting data embedding unique to a domain based on a sample set of each domain (step S3), and stores the trained predictor 141 in the storage unit 14.

[Procedure of Prediction Processing]

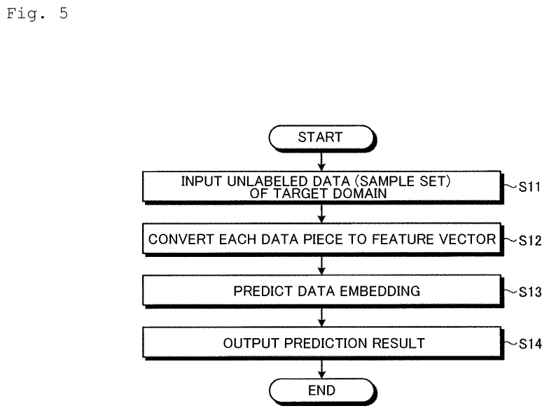

Next, prediction processing performed by the prediction device 20 will be described with reference to FIG. 5. FIG. 5 is a flowchart showing an example procedure of the prediction processing performed by the prediction device 20 shown in FIG. 3.

As shown in FIG. 5, in the prediction device 20, the data input unit 21 accepts input of unlabeled data (sample set) of a target domain (step S11). The feature extraction unit 22 converts data of each domain of which input was accepted in step S11, to a feature vector (step S12).

Then, the prediction unit 23 predicts data embedding from the sample set by using the predictor 141 trained by the training device 10 (step S13). The output unit 24 outputs the result of prediction performed by the prediction unit 23 (step S14).

[Training Phase]

Next, an example of a training phase in the training device 10 will be described in detail. First, assume that D_{d} shown in Expression (1) represents data of the d-th source domain.

$$[ Math . 1 ]$$

$${𝔇}_{d} := {\{ {X}_{d} , {Y}_{d} \}}_{n = 1}^{{N}_{d}} \qquad ( 1 )$$

Here, X_{d} shown in Expression (2) represents a sample set of feature vectors of the d-th source domain.

$$[ Math . 2 ]$$

$${X}_{d} : = {\{ {x}_{dn} \}}_{n = 1}^{{N}_{d}} \qquad ( 2 )$$

x_{dn} in Expression (2) is a C-dimensional feature vector of the n-th sample of the d-th source domain. Note that x_{dm} (described later) is a C-dimensional feature vector of the m(≠n)-th sample of the d-th source domain.

Y_{d} shown in Expression (3) is a label set of the d-th source domain.

$$[ Math . 3 ]$$

$${Y}_{d} : = \{ {y}_{d n m} \} \qquad ( 3 )$$

y_{dnm}∈{0,1} in Expression (3) is a label that represents 1 if x_{dn} and x_{dm} are similar to each other, and represents 0 if x_{dn} and x_{dm} are dissimilar. Note that y_{dnm} need not be necessarily given to a pair (n,m).

An object that is to be achieved here is to construct a predictor that predicts data embedding unique to a domain when labeled and/or unlabeled data D of D types of source domains shown in Expression (4) are given in training.

[Math. 4]

[symbol]

=U_{d=1}^{D} [symbol] _{d} (4)

In the present embodiment, the predictor is constructed using a probabilistic model. First, assume that each domain d has a K_{z}-dimesional latent variable z_{d}. Hereinafter, the latent variable z_{d} will be referred to as a “latent domain vector”. The latent domain vector z_{d} is generated from a standard Gaussian distribution p(z)=N (z|0,I).

Also, assume that a sample x_{dn} of each domain similarly has a Ku-dimensional latent variable u_{dn}. The latent variable u_{dn} will be referred to as a “latent feature vector”. The latent feature vector u_{dn} is generated from a standard Gaussian distribution p(u)=N(u|0,I). The latent feature vector U_{d}={U_{dn}} is data embedding of the domain d.

Each sample x_{dn} is generated depending on the latent feature vector u_{dn} and the latent domain vector z_{d}. That is, p_{θ}(x_{dn}|u_{dn},z_{d}). A parameter of this distribution is represented by a neural net (parameter θ).

The latent domain vector z_{d} is a variable that serves to characterize each domain. Therefore, p_{θ}(x_{dn}|u_{dn},z_{d}) expresses a probability distribution that is unique to each domain.

The label y_{dnm} for x_{dn} and x_{dm} is generated in accordance with a Bernoulli distribution expressed by the following Expressions (5) and (6).

$$[ Math . 5 ]$$

$$\begin{matrix}p ( {y}_{d n m} \vert {u}_{d n} , {u}_{d m} ) = {( {ϕ}_{d n m} )}^{{y}_{d n m}} {( 1 - {ϕ}_{d n m} )}^{1 - {y}_{d n m}} \\ \\ [ Math . 6 ] & ( 5 ) \\ {ϕ}_{d n m} : = \frac{1}{1 + {‖ {u}_{d n} - {u}_{d m} ‖}^{2}} & ( 6 )\end{matrix}$$

If y_{dnm}=1, Expression (5) is maximized when u_{dn}−u_{dm}→0. That is, in this case, the two latent feature vectors get closer to each other. On the other hand, if y_{dnm}=0, Expression (5) is maximized when u_{dn}−u_{dm}→∞. That is, in this case, the two latent feature vectors get away from each other. Accordingly, the training unit 13 can obtain desired data embedding (latent feature vector) by carrying out training such that the probability distribution is maximized. To summarize the generation procedure described above, a joint distribution regarding the domain d is expressed by the following Expression (7).

$$[ Math . 7 ]$$

$${p}_{θ} ( {X}_{d} , {Y}_{d} , {U}_{d} , {z}_{d} ) = {\prod }_{( n , m ) ∈ {R}_{d}} p ( {y}_{dnm} \vert {u}_{dn} , {u}_{dm} ) \cdot {\prod }_{n = 1}^{{N}_{d}} {p}_{θ} ( {x}_{dn} \vert {u}_{dn} , {z}_{d} ) p ( {u}_{dn} ) \cdot p ( {z}_{d} ) \qquad ( 7 )$$

The second term on the left side of Expression (7) corresponds to estimation of x_{dn} that is output when u_{dn} and z_{d} are given. Here, R_{d} is a set of pairs that have labels in the domain d. If R_{d}=0, i.e., if labels are not included in the domain d, p(y_{dnm}|u_{dn},u_{dm}) in Expression (7) can be omitted. In other words, Expression (7) can be applied to unlabeled data of the source domains.

Log marginal likelihood in the present embodiment is expressed by Expression (8).

$$[ Math . 8 ]$$

$$ln p ( 𝒟 ) = ln ( {\prod }_{d = 1}^{D} \int \int {p}_{θ} ( {X}_{d} , {Y}_{d} , {U}_{d} , {z}_{d} ) ⅆ {U}_{d} ⅆ {z}_{d} ) \qquad ( 8 )$$

If the log marginal likelihood can be analytically calculated, posterior distributions of the latent domain vector and the latent feature vector can be obtained. However, such calculation cannot be performed. Therefore, these posterior distributions are approximated using the following Expressions (9) to (11).

$$[ Math . 9 ]$$

$$\begin{matrix}{q}_{ϕ} ( {U}_{d} , {z}_{d} \vert {X}_{d} ) := {\prod }_{n = 1}^{{N}_{d}} {q}_{{ϕ}_{u}} ( {u}_{dn} \vert {x}_{dn} , {z}_{d} ) \cdot {q}_{{ϕ}_{z}} ( {z}_{d} \vert {X}_{d} ) \\ [ Math . 10 ] & ( 9 ) \\ {q}_{ϕ} ( {z}_{d} \vert {X}_{d} ) := 𝒩 ( {z}_{d} \vert {μ}_{{ϕ}_{2}} ( {X}_{d} ) , {σ}_{{ϕ}_{u}}^{2} ( {X}_{d} ) ) \\ [ Math . 11 ] & ( 10 ) \\ {q}_{{ϕ}_{u}} ( {u}_{dn} \vert {x}_{dn} , {z}_{d} ) := 𝒩 ( {u}_{dn} \vert {μ}_{{ϕ}_{u}} ( {x}_{dn} , {z}_{d} ) , {σ}_{{ϕ}_{u}}^{2} ( {x}_{dn} , {z}_{d} ) ) & ( 11 )\end{matrix}$$

Here, an average function and a covariance function of q_{φz} and q_{φu} are suitable neural networks, and φ_{z} and φᵤ are parameters of the neural networks. Since q_{φn} is modeled to be dependent on z, a tendency of data embedding U_{d}={u_{dn}} can be controlled by varying z_{d}.

As for q_{φz}, it is necessary that the set X_{d} can be taken as an input. An average function and a covariance function of this distribution are expressed with an architecture of the form of the following Expression (12), for example.

$$[ Math . 12 ]$$

$$τ ( {X}_{d} ) = ρ ( \frac{1}{{N}_{d}} {\sum }_{n = 1}^{{N}_{d}} η ( {x}_{dn} ) ) \qquad ( 12 )$$

Here, ρ and η are suitable neural networks. As a result of the architecture being defined as described above, a constant output can be always returned independently of the order of the sample set. That is, it is possible to take the set X_{d} as an input when finding q_{φz}.

Also, if an average is taken as the output of η, a result can be stably output even if the number of samples differs between domains. Note that in the present embodiment, it is possible to take a set as an input by using not only the architecture of this form (average) but also max pooling or sum.

The lower bound of the log marginal likelihood is expressed by Expression (13) using the approximated posterior distributions described above.

$$[ Math . 13 ]$$

$$lnp ( 𝒟 ) ≧ ℒ ( 𝒟 ; θ , ϕ ) := {\sum }_{d = 1}^{D} [ - {D}_{K L} ( {q}_{{ϕ}_{z}} ( {z}_{d} \vert {X}_{d} ) ‖ p ( {z}_{d} ) ) - {𝔼}_{{q}_{{ϕ}_{z}}} 〈 {z}_{d} \vert {X}_{d} 〉 [ {\sum }_{n = 1}^{{N}_{d}} {D}_{K L} ( {q}_{{ϕ}_{u}} ( {u}_{d n} \vert {x}_{d n} \cdot {z}_{d} ) ‖ p ( {u}_{d n} ) ) ] + {𝔼}_{{q}_{ϕ}} ( {U}_{d} , {z}_{d} \vert {X}_{d} ) [ {\sum }_{n = 1}^{{N}_{d}} ln {p}_{θ} ( {x}_{dn} \vert {u}_{dn} , {z}_{d} ) ] + {𝔼}_{{q}_{ϕ}} ( {U}_{d} , {z}_{d} \vert {X}_{d} ) [ {\sum }_{( n , m ) ∈ {R}_{d}} ln {p}_{θ} ( {y}_{dnm} \vert {u}_{dn} , {u}_{dm} ) ] ] \qquad ( 13 )$$

The lower bound can be approximated in a computable form as shown in the following Expression (14) by using reparametrization trick.

$$[ Math . 14 ]$$

$$ℒ ( 𝒟 ; θ , ϕ ) \approx {\sum }_{d = 1}^{D} [ - {D}_{KL} ( {q}_{{ϕ}_{z}} ( {z}_{d} \vert {X}_{d} ) ‖ p ( {z}_{d} ) ) - \frac{1}{{L}_{2}} {\sum }_{l = 1}^{{L}_{2}} {\sum }_{n = 1}^{{N}_{d}} {D}_{KL} ( {q}_{{ϕ}_{u}} ( {u}_{dn} \vert {x}_{dn} , {z}_{d}^{( l )} ) ‖ p ( {u}_{dn} ) ) + \frac{1}{{L}_{2} {L}_{u}} {\sum }_{l = 1}^{{L}_{2}} {\sum }_{{l}^{′} = 1}^{{L}_{u}} {\sum }_{n = 1}^{{N}_{d}} ln {p}_{θ} ( {x}_{dn} \vert {u}_{dn}^{( {l}^{′} , l )} , {z}_{d}^{( l )} ) + \frac{1}{{L}_{z} {L}_{u}^{2}} {\sum }_{l = 1}^{{L}_{z}} {\sum }_{{l}^{′} , {l}^{″} = 1}^{{L}_{u}} {\sum }_{( n , m ) ∈ {R}_{d}} ln {p}_{θ} ( {y}_{dnm} \vert {u}_{dn}^{( {l}^{′} , l )} , {u}_{dm}^{( {l}^{″} , l )} ) ] \qquad ( 14 )$$

Here, z_{d}^{(l)} is expressed as shown in Expression (15). u_{dn}^{(l′,l)} is expressed as shown in Expression (16). l′ is expressed as shown in Expression (17). ε is a sample from a standard normal distribution.

$$[ Math . 15 ]$$

$$\begin{matrix}{z}_{d}^{( l )} = {μ}_{{ϕ}_{z}} ( {X}_{d} ) + {ϵ}_{d}^{( l )} ⊙ {σ}_{{ϕ}_{z}} ( {X}_{d} ) \\ [ Math . 16 ] & ( 15 ) \\ {u}_{dn}^{( {l}^{′} , l )} = {μ}_{{ϕ}_{u}} ( {x}_{dn} , {z}_{d}^{( l )} ) + {ϵ}_{dn}^{( {l}^{′} )} ⊙ {σ}_{{ϕ}_{u}} ( {x}_{dn} , {z}_{d}^{( l )} ) \\ [ Math . 17 ] & ( 16 ) \\ {l}^{′} = 1 , … , {L}_{u} & ( 17 )\end{matrix}$$

A desired predictor can be obtained by maximizing the lower bound L shown in Expression (14) with respect to the parameters θ and φ. The maximization can be carried out with a common method using stochastic gradient descent (SGD).

[Prediction Phase]

Next, an example of a prediction phase in the prediction device 20 will be described in detail. The following describes the prediction phase using the specific example used in the description of the training phase. If a sample set of a target domain d* shown in Expression (18) is given, a distribution of data embedding is predicted using the following Expression (19).

$$[ Math . 18 ]$$

$$\begin{matrix} {X}_{d *} := {\{ {x}_{d * n} \}}_{r ι = i}^{{N}_{d *}} \\ \\ [ Math . 19 ] & ( 18 ) \\ q ( {u}_{d * n} \vert {x}_{d * n} ) = \int {q}_{{ϕ}_{u}} ( {u}_{d * n} \vert {x}_{d * n} , {z}_{d *} ) {q}_{{ϕ}_{z}} ( {z}_{d *} \vert {X}_{d *} ) {dz}_{d *} \approx \frac{1}{{L}_{z}} {{\sum }^{{L}_{z}}}_{l = 1} {q}_{{ϕ}_{u}} ( {u}_{d * n} \vert {x}_{d * n} , {z}_{d *}^{( l 〉} ) , \\ Here , {z}_{{d}_{*}}^{( l )} = {μ}_{ϕ} ( {X}_{d *} ) + {ϵ}^{( l )} {σ}_{ϕ} ( {X}_{d *} ) , {ϵ}^{( l 〉} ∼ N ( 0 , I ) & ( 19 )\end{matrix}$$

[Effects of Embodiment]

As described above, the training device 10 according to the embodiment converts data unique to each source domain among labeled data and/or unlabeled data of the source domain, which is training data, to a feature vector, and trains the predictor 141 that performs data embedding suited to an input domain, in accordance with metric learning by using the feature vector of each source domain.

In conventional methods, information that is common to all domains is used, and information unique to each domain is not used. In contrast, in the present embodiment, the predictor 141 that predicts data embedding unique to each domain is trained by using information unique to each domain as well. Therefore, with the prediction system according to the present embodiment, data embedding suited to a target domain can be predicted without necessary information being lost, by using the predictor 141 trained using information unique to each domain as well.

Also, in the present embodiment, the predictor 141 includes the first model and the second model. When a feature vector of a domain is input, the first model estimates a latent feature vector and a latent domain vector with respect to the input domain. The second model outputs a feature vector of the domain when the domain latent feature vector and the latent domain vector that are estimated by the first model are input. Owing to these two models, the predictor 141 in the present embodiment can use even a domain that only includes unlabeled data, in training.

Therefore, according to the present embodiment, information loss can be prevented by using information unique to each domain as well. Furthermore, according to the present embodiment, a domain to which label information is not given can also be used as training data, and therefore highly precise data embedding suited to a target domain can be obtained with respect to actual problems in a wide range.

That is, according to the present embodiment, it is possible to prevent information loss and predict data embedding suited to a target domain regardless of the presence or absence of labels of data in a source domain for training.

[System Configuration of Embodiment]

The constitutional elements of the training device 10 and the prediction device 20 shown in FIG. 3 represent functional concepts, and the training device 10 and the prediction device 20 do not necessarily have to be physically configured as shown in FIG. 3. That is, specific manners of distribution and integration of the functions of the training device 10 and the prediction device 20 are not limited to those illustrated, and all or some portions of the training device 10 and the prediction device 20 may be functionally or physically distributed or integrated in suitable units according to various types of loads or conditions in which the training device 10 and the prediction device 20 are used.

Also, all or some steps of each piece of processing executed in the training device 10 and the prediction device 20 may be realized using a CPU and a program that is analyzed and executed by the CPU. Also, each piece of processing executed in the training device 10 and the prediction device 20 may be realized as hardware using a wired logic.

Also, out of the pieces of processing described in the embodiment, all or some steps of a piece of processing that is described as being automatically executed may also be manually executed. Alternatively, all or some steps of a piece of processing that is described as being manually executed may also be automatically executed using a known method. The processing procedure, control procedure, specific names, and information including various types of data and parameters that are described above and shown in the drawings may be changed as appropriate unless otherwise stated.

[Program]

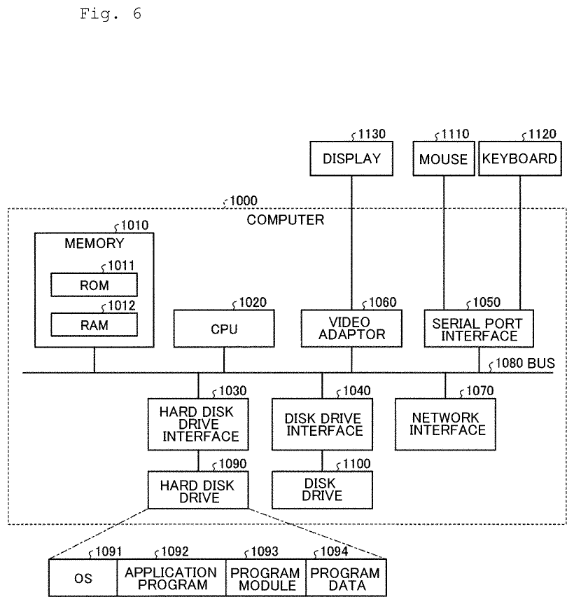

FIG. 6 is a diagram showing an example of a computer with which the training device 10 and the prediction device 20 are realized through execution of a program. A computer 1000 includes a memory 1010 and a CPU 1020, for example. Also, the computer 1000 includes a hard disk drive interface 1030, a disk drive interface 1040, a serial port interface 1050, a video adaptor 1060, and a network interface 1070. These units are connected via a bus 1080.

The memory 1010 includes a ROM 1011 and a RAM 1012. A boot program such as BIOS (Basic Input Output System) is stored in the ROM 1011, for example. The hard disk drive interface 1030 is connected to a hard disk drive 1090. The disk drive interface 1040 is connected to a disk drive 1100. An attachable and detachable storage medium such as a magnetic disk or an optical disc is inserted into the disk drive 1100. The serial port interface 1050 is connected to a mouse 1110 and a keyboard 1120, for example. The video adaptor 1060 is connected to a display 1130, for example.

An OS 1091, an application program 1092, a program module 1093, and program data 1094 are stored in the hard disk drive 1090, for example. That is, a program that defines each piece of processing performed by the training device 10 and the prediction device 20 is implemented as the program module 1093 in which codes that can be executed by the computer 1000 are written. The program module 1093 is stored in the hard disk drive 1090, for example. For example, the program module 1093 for executing processing similar to the functional configurations of the training device 10 and the prediction device 20 is stored in the hard disk drive 1090. Note that the hard disk drive 1090 may be replaced with a SSD (Solid State Drive).

Setting data that is used in the processing executed in the embodiment described above is stored as the program data 1094 in the memory 1010 or the hard disk drive 1090, for example. The CPU 1020 reads out the program module 1093 and the program data 1094 stored in the memory 1010 or the hard disk drive 1090 into the RAM 1012 as necessary and executes the program module 1093 and the program data 1094.

Note that the program module 1093 and the program data 1094 do not necessarily have to be stored in the hard disk drive 1090, and may also be stored in an attachable and detachable storage medium and read out by the CPU 1020 via the disk drive 1100 or the like. Alternatively, the program module 1093 and the program data 1094 may also be stored in another computer that is connected via a network (LAN (Local Area Network), WAN (Wide Area Network), etc.). The program module 1093 and the program data 1094 may also be read out from the other computer by the CPU 1020 via the network interface 1070.

Although the embodiment to which the invention made by the inventor is applied has been described, the present invention is not limited by descriptions and drawings that constitute portions of disclosure of the present invention according to the embodiment. That is, all other embodiments, examples, operation technologies, and the like that are made by those skilled in the art based on the present embodiment are encompassed in the scope of the present invention.

### REFERENCE SIGNS LIST

10 Training device
11 Training data input unit
12, 22 Feature extraction unit
13 Training unit
14 Storage unit
20 Prediction device
21 Data input unit
23 Prediction unit
24 Output unit
141 Predictor

1. A training device, comprising:
input circuitry configured to accept input of labeled data of a source domain and/or unlabeled data of a source domain as training data;
feature extraction circuitry configured to convert data unique to each source domain of which input has been accepted by the input circuitry, to a feature vector; and
training circuitry configured to train a predictor that performs data embedding suited to an input domain, in accordance with metric learning by using the feature vector of each source domain.

2. The training device according to claim 1, wherein:
the predictor includes a first model and a second model, the first model estimating, when a feature vector set of a domain is input, a latent feature vector that is a latent variable of a feature vector of the input domain and a latent domain vector that indicates information regarding the domain that is information regarding a data set of the input domain, the second model outputting a feature vector of the domain when the latent feature vector and the latent domain vector of the domain that are estimated by the first model are input.

3. A training method to be executed by a training device, comprising:
accepting input of labeled data of a source domain and/or unlabeled data of a source domain as training data;
converting data unique to each source domain of which input has been accepted, to a feature vector; and
training a predictor that performs data embedding suited to an input domain, in accordance with metric learning by using the feature vector of each source domain.

4. A prediction system comprising:
a training device configured to train a predictor; and
a prediction device configured to predict data embedding suited to a target domain by using the predictor,
wherein the training device includes:
first input circuitry that accepts input of labeled data of a source domain and/or unlabeled data of a source domain as training data;
first feature extraction circuitry that converts data unique to each source domain of which input has been accepted by the first input circuitry, to a feature vector; and
training circuitry that trains a predictor that performs data embedding suited to an input domain, in accordance with metric learning by using the feature vector of each source domain, and
the prediction device includes:
second input circuitry that accepts input of unlabeled data of a target domain that is a prediction target;
second feature extraction circuitry that converts data unique to the target domain of which input has been accepted by the second input circuitry, to a feature vector; and
prediction circuitry that performs data embedding suited to the target domain based on the feature vector converted by the second feature extraction circuitry, by using the predictor trained by the training circuitry.
